(19) United States
(12) Patent Application Publication
(10) Pub. No.: US 2010/0017579 A1
(43) Pub. Date: Jan. 21, 2010

(54) Program-Controlled Unit and Method for Operating Same

(76) Inventors: Bernd Mueller, Leonberg-Silberberg (DE); Thomas Kottke, Ehningen (DE); Yorck von Collani, Bellstein (DE)

Correspondence Address: KENYON & KENYON LLP, ONE BROADWAY, NEW YORK, NY, 10004, US

(21) Appl. No.: 12/085,064

(22) PCT Filed: Oct. 18, 2006
(86) PCT No.: PCT/EP2006/067555

§ 371 Date: Aug. 25, 2009

(30) Foreign Application Priority Data
Nov. 16, 2005 (DE) 10 2005 054 587.4

(51) Int. Cl. G06F 15/76; G06F 9/06

(52) U.S. Cl. 712/30; 712/E09.003

(57) ABSTRACT

A method for operating a program-controlled unit has two redundantly operable microprocessor cores and a comparator unit provided downstream from the two microprocessor cores. One working register having a different content is provided in each of the two microprocessor cores for the redundant operation, and the content of these working registers is fed to the downstream comparator unit in order to verify whether the comparator unit signals a difference.

### FIELD OF THE INVENTION

The present invention relates to a program-controlled unit having two redundantly operable microprocessor cores, and a method for operating such a unit.

### BACKGROUND INFORMATION

Such program-controlled units are designed, for example, as microprocessors, microcontrollers, signal processors, or the like. A microcontroller or microprocessor has a microcontroller core or a microprocessor core, the so-called core, one or more memories (program memory, data memory, etc.), peripheral components (oscillator, I/O ports, timer, AD converter, DA converter, communication interfaces), and an interrupt system, which as a whole are integrated on a chip and are interconnected via one or more buses (internal, external data/address bus). The structure and mode of operation of such a program-controlled unit are well known, and therefore require no explanation here.

In the sense of a modular microcontroller design, the microcontroller core is the on-chip integrated central control unit (CPU). The microcontroller core essentially contains a more or less complex processor, multiple registers (data and address registers), a bus control unit, and a computing unit which performs the actual data processing function. The input data (operands) entered into the computing unit as well as the results of the computation by the computing unit may be stored, before or after the processing, in registers or memory locations specifically provided for this purpose. During processing or also during entry of the operands, errors may occur which may have an adverse effect on the results. Corruption of operands entered on the input side may occur, for example, if the potential which represents the particular input data item is higher or lower than intended. When the potential is greater or less than a specified threshold, the potential which represents one logical state may represent another logical state which is different from that originally intended. For example, a logical “1” may be changed to a logical “0,” which may significantly distort the results of the computation. On the other hand, of course, an incorrect computation by the computing unit may result in such distorted results.

For this reason, modern microprocessor systems are equipped with a system for error recognition or error elimination via which occurrence of errors may be identified and displayed (failure identification), or, as a function of the functionality of the system, measures may be taken when an error has occurred. One possibility for error recognition is the use of redundant hardware, two microprocessor cores and a comparator unit provided downstream from the two cores being used instead of one microprocessor core. In such dual-processor systems (dual cores), in redundant operation with identical input data using the above-named comparator unit, when the results from the two cores do not agree, the comparator unit generates an error signal. Such a computer system is described in PCT International Patent Publication No. WO 01/46806, for example.

A microcontroller having an error recognition system and a method for operating the same is described in German Patent Application No. DE 103 17 650 by the present applicant. In this case, the microcontroller has an individual microcontroller core which contains two computing units (arithmetic logic units (ALUs)) for data processing. Thus, in this case the entire microcontroller core does not have a redundant design. The necessary chip surface may therefore be significantly reduced. The error recognition occurs in test mode, with identical instructions or data being coupled in parallel in both computing units. The checksums for the data entered into the two computing units are generated on the input side. The particular checksum is compared to the checksum stored in a corresponding register, and in the event of corruption, the data are corrected and reentered. Each of the two executing or computing units of the microcontroller generates a result which must agree with the same entered data. The result data and/or the coding thereof (ECC checksum) are compared to one another in a comparator unit. If there is agreement, an enable signal is generated; otherwise, it may be concluded that an error has occurred within one of the executing units, or that faulty encoding of the result has occurred. It is possible to recognize transient, permanent, and run-time errors.

A method and a device for comparing binary data words for security-relevant vehicle systems, such as ABS, ESP, steering and chassis controls, are described in German Patent Application No. DE 103 17 651 by the present applicant. The present description is based on a dual-core computer, i.e., a microcontroller having two CPUs (central computing units) in which all functions are redundantly computed and the particular output values are compared to one another. If the output values do not agree, a system response to the error occurs which may also include shutdown of the system. For appropriate handling of errors, the cited document provides that the more significant, higher-order bits of the data words of the output values are compared with one another separately from the less significant, lower-order bits. If the less significant, lower-order bits do not agree, appropriate error handling may be performed in which, for example, instead of a negative comparison result, a replacement value is forwarded which as a whole results in a positive overall result when the more significant, higher-order bits of the data words agree.

Although the present invention is directed to dual-processor systems (dual cores), it also aims to include processor systems which contain a single microcontroller core having two computing units (see German Patent Application No. DE 103 17 650).

The comparator units for the output data represent a possible single point of failure, which is a common problem with all of the dual-processor systems described above. A faulty comparator unit causes an error to be displayed, even if the cores or computing units are operating properly. Even worse is the case in which, as the result of a faulty comparator unit, improperly operating cores or computing units are not recognized because the comparator unit does not signal a difference in the signals.

Heretofore, the comparator units have been tested by splitting the data path at the data input and entering external data. Alternatively, the comparator unit may have a self-testing design (totally self-checking (TSC)), although this involves increased hardware complexity. A switchover device upstream from the comparator unit, which enters various data only for test purposes, itself represents a possible single point of failure, and therefore should be avoided. In that case there is the problem, for example, of ensuring that the switchback functions correctly.

Therefore, there is a need for easily testing the above-named comparator units without having to switch over the data path of the processor.

### SUMMARY OF THE INVENTION

Compared to the known approaches, the method according to the present invention for operating a program-controlled unit having two redundantly operable microprocessor cores and a corresponding program-controlled unit according to the present invention have the advantage of a simplified comparison test without increasing the space requirements for the chip.

The present invention is directed to a program-controlled unit having two redundantly operable microprocessor cores and a comparator unit provided downstream from one of these two cores. According to the present invention, one working register having a different content is provided in each of the two cores for the redundant operation. This is the only difference in these dual-processor systems. The register contents are supplied to the comparator unit in order to verify whether the comparator unit signals a difference. In practice, the register contents are supplied to the data bus via load-store operations. Since the register contents are different, the properly operating comparator unit must signal a difference no later than at the time of the writeback of the value into memory.

By use of the present invention, the comparator unit may be easily tested as a possible single point of failure without increasing the space requirements for the chip.

It is advantageous for one register having different contents to be provided in each of the two microprocessor cores, the contents of the particular working registers being formed by processing or copying the contents of the differing registers. In this case, two different registers are provided in the microprocessor cores, both processors executing a program in lock mode, for example, for testing of the comparator unit, and the program first copying the contents of the differing registers to the corresponding working registers. The contents of each working register are then written into a memory, for example, via the comparator unit. If the comparator unit is operating correctly, it generates an error signal since the contents of the working registers and of the registers are different. Instead of the above-named copying procedure, the contents of the particular working registers may also be formed by another type of processing of the contents of the differing registers.

If no modifications are to be made to standard processes, it is advantageous for the microprocessor cores to deliver a data item having a different value when the microprocessor cores access a defined address in the address space. In this case, when defined addresses are accessed, different contents are delivered due to the contents of the particular working registers. These defined addresses may belong to registers which are present in the comparator unit, for example.

Registers which are already present may advantageously be used in redundantly operable microprocessor cores for the present invention. For dual-core processors (dual cores/split/log processors) which in a first operating mode may be operated independently of one another, and in a second operating mode may be operated redundantly, as a rule registers exist which in separate operation allow the software to ascertain the particular CPU (core) upon which the software is being executed at that moment. When a switch is made to redundant operation, the register contents are preserved, and are therefore different.

To ensure the most complete error detection possible, it is advantageous to modify the contents of the two working registers, the contents still being different after a modification. To this end, the contents of the working registers may be modified in particular by using the same logical gating or operation on both registers. Such an operation with any other given values, which in fact are the same in both processors, allows any bit pattern and any bit pattern difference to be generated in the two microprocessor cores. Thus, a complete test of the comparator unit is possible. The errors which occur also include stuck-at errors and coupling errors. For stuck-at errors, a line remains at a high or low voltage level although the voltage level has already been lowered or raised, respectively. Occurrences of this error may be permanent or transient (for a certain time period). Coupling errors are understood to mean the jumping of a voltage level to a parallel line. To allow reliable testing of all errors, permutations (in which the number of “1's” and “0's” is different) are necessary. If the register content of core 1 is “0001,” for example, and that of core 2 is “0010,” the register content of core 1 may be set to “0001” and that of core 2 may be set to “0000” by use of the logical operation “AND 0001” whereas the logical operation for the latter-referenced register content by use of the “NOT” operator results in the register content of “1110” for core 1 and “1111” for core 2.

It is consequently clear to those skilled in the art that any given register contents may be generated.

It may be practical to provide an additional comparator unit for read accesses of instructions or data, such a comparator unit once again representing a single point of failure. For testing such a comparator unit, the instructions or data sent to the two microprocessor cores are modified via program branches in order to verify whether the comparator unit signals a difference for read accesses. By use of such a jump operation, the instruction sent, for example, to core 1 is placed at another location for core 2, so that for read accesses in fault-free operation the comparator unit must determine that different instructions are sent to the two cores.

The above-described designs for the present invention apply in the same manner to the claimed program-controlled unit having two redundantly operable microprocessor cores and to a comparator unit provided downstream from the two microprocessor cores. To avoid repetition, reference is made to the above description. It is further emphasized that the features of the present invention may be used not only in the combinations stated, but also in other combinations or singly.

### BRIEF DESCRIPTION OF THE DRAWINGS

FIG. 1 shows a schematic illustration of a first embodiment of the present invention.

FIG. 2 shows a schematic illustration of an alternative embodiment of the present invention.

### DETAILED DESCRIPTION

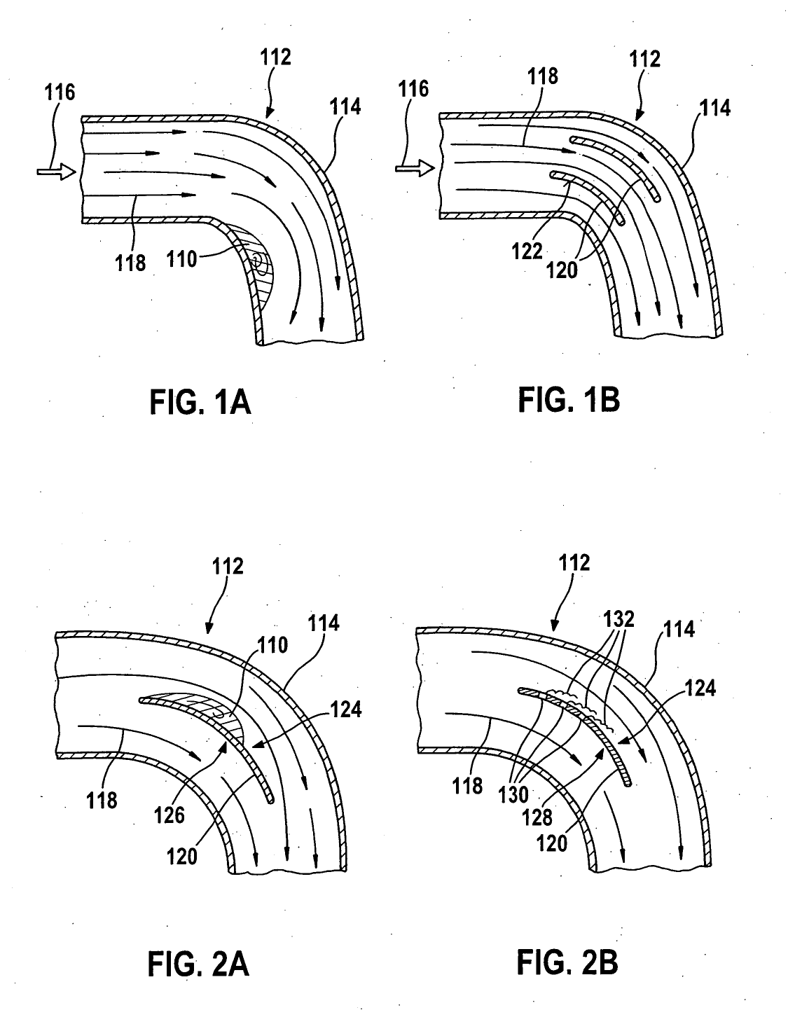

FIG. 1 shows one possible embodiment of the present invention. Overall system 100 has two processors (cores) 110 and 120, each containing a register 111 or 121, respectively, having different contents. Both processors are connected to a comparator unit 130, which in turn is connected via an interface 140 to other computing units such as memories or peripherals (not illustrated). Depending on the design, the comparator unit compares only write operations, or write and read operations, of the processors for agreement.

To test comparator unit 130, both processors execute a program in lock mode, the program first copying registers 111 and 121 into working registers 112 and 122, respectively. The contents of each working register are then written into the memory via comparator unit 130 and interface 140. When comparator unit 130 is operating correctly, it generates an error signal since the contents of registers 112 and 122 are different, and also since the contents of registers 111 and 121 are different. For complete testing of comparator unit 130, after copying into the working register the value of registers 111 and 121, they may be manipulated as previously described, for example by use of logical operations. If read operations are also compared by comparator unit 130, a test is performed by branching of the program control flow.

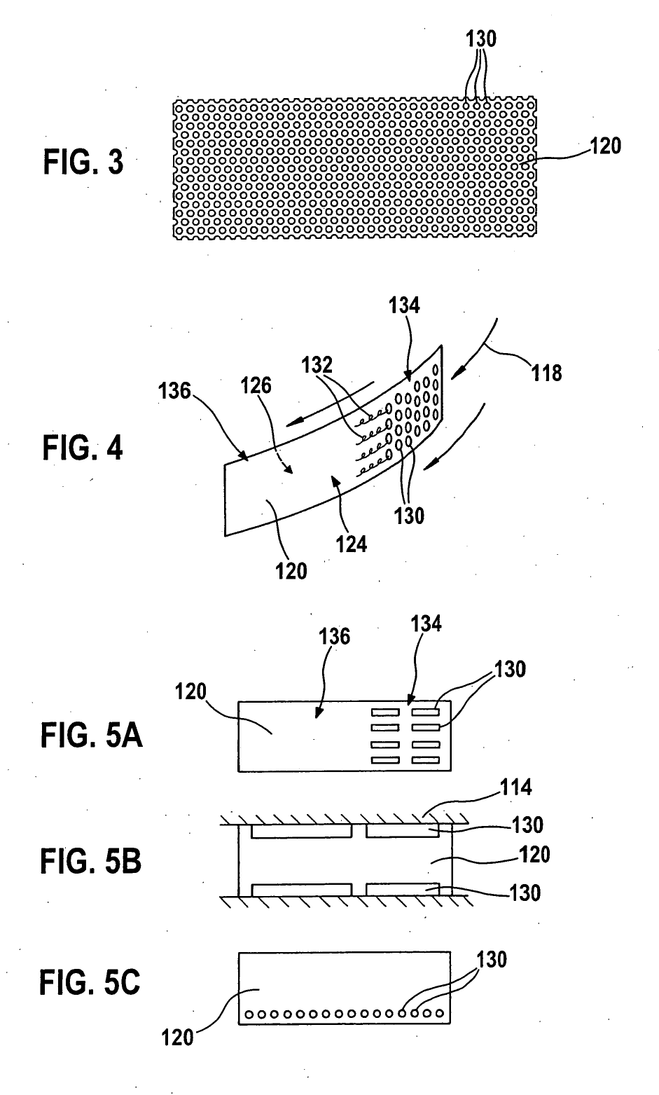

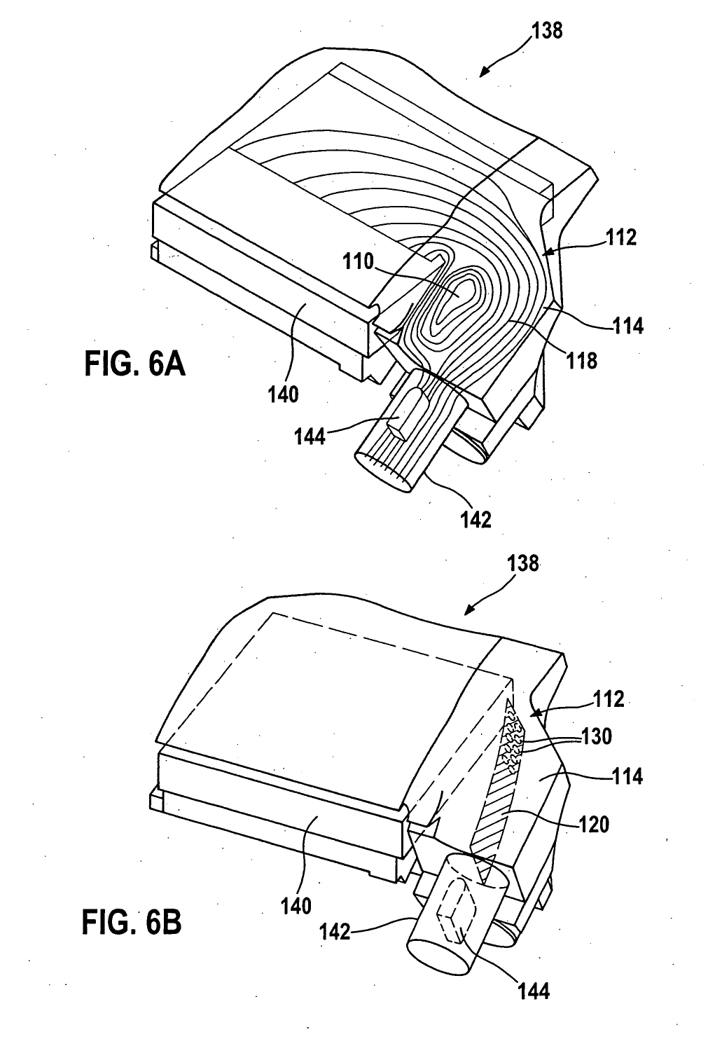

FIG. 2 shows an alternative embodiment of the present invention. Overall system 200 has two processors (cores) 210 and 220, each having a working register 212 and 222, respectively. In contrast to system 100, the processors have an identical design and have no register with differing contents. Both processors are connected to a comparator unit 230, which in turn is connected via an interface 240 to other computing units such as memories or peripherals (not illustrated). Comparator unit 230 has two registers 231 and 232. The contents of these registers are different. The processors may copy (load) the contents of these registers into a working register by the processor accessing a defined address in the address space. The comparator unit detects the access to this address, and delivers the contents of register 231 to processor 210 and the contents of register 232 to processor 220. In this case, the access is not relayed to interface 240. Depending on the design, the comparator unit compares only write operations, or write and read operations, of the processors for agreement. The remainder of the test procedure is identical to that previously described.

1-12. (canceled)

13. A method for operating a program-controlled unit including two redundantly operable microprocessor cores and a comparator unit situated downstream from the two microprocessor cores, the method comprising:
providing one working register having a different content in each of the two microprocessor cores for the redundant operation; and
applying the content of the working registers to the downstream comparator unit in order to verify whether the comparator unit signals a difference.

14. The method according to claim 13, wherein one register having a different content is provided in each of the two microprocessor cores, the content of the particular working registers being formed by processing or copying the contents of the differing registers.

15. The method according to claim 13, further comprising delivering the content of the particular working registers by respectively accessing defined addresses having a different content.

16. The method according to claim 15, wherein the addresses having a different content belong to registers which are situated in the comparator unit.

17. The method according to claim 13, further comprising modifying the contents of the two working registers in such a way that the contents of the working registers remain different after a modification.

18. The method according to claim 17, wherein the contents of the working registers are modified by using the same logical operation on the working registers.

19. The method according to claim 13, wherein an additional comparator unit is provided for read accesses of instructions or data, and further comprising modifying the instructions or data sent to the two microprocessor cores via program branches in order to verify whether the additional comparator unit signals a difference for read accesses.

20. A program-controlled unit comprising:
two redundantly operable microprocessor cores, each of the two microprocessor cores including one working register having a different content for the redundant operation;
a comparator unit situated downstream from the two microprocessor cores; and
means for applying the content of the working registers to the downstream comparator unit in order to verify whether the comparator unit signals a difference.

21. The program-controlled unit according to claim 20, wherein one register having different content is provided in each of the two microprocessor cores in order to form the content of the particular working registers by processing the contents of the differing registers.

22. The program-controlled unit according to claim 20, wherein two registers having a different content are provided in the comparator unit, the content of the registers being loaded into the working registers of the microprocessor cores by: accessing defined addresses.

23. The program-controlled unit according to claim 20, further comprising means for modifying respective content of the two working registers, the contents of the registers still being different from one another after the modification.

24. The program-controlled unit according to claim 20, further comprising:
an additional comparator unit for read accesses of instructions or data; and
means for modifying the instructions or data via program branches in order to verify whether the additional comparator unit signals a difference for read accesses.
